(19) United States
(12) Patent Application Publication
(10) Pub. No.: US 2023/0240367 A1
(43) Pub. Date: Aug. 3, 2023

(54) APPARATUS FOR HEATING AERSOLISABLE MATERIAL

(71) Applicant: NICOVENTURES TRADING LIMITED, London (GB)

(72) Inventors: Mitchel THORSEN, Madison, WI (US); Luke WARREN, London (GB)

(21) Appl. No.: 18/002,989

(22) PCT Filed: Jun. 24, 2021
(86) PCT No.: PCT/EP2021/067428

§ 371 Date: Dec. 22, 2022

Related U.S. Application Data
(60) Provisional application No. 62/705,429, filed on Jun. 26, 2020.

(51) Int. Cl. A24F 40/46; A24F 40/70; A24F 40/20

(52) U.S. Cl. CPC A24F 40/46; A24F 40/20; A24F 40/70; A24F 40/50

(57) ABSTRACT

An apparatus arranged to heat aerosolizable material to volatilize at least one component of the aerosolizable material is disclosed. The apparatus includes a conductive wire defining a receiving portion arranged to receive a consumable article including aerosolizable material and a support structure encapsulating at least an outer edge of the conductive wire to thereby support the receiving portion.

### PRIORITY CLAIM

The present application is a National Phase entry of PCT Application No. PCT/EP2021/067428, filed Jun. 24, 2021, which claims priority from U.S. Application No. 62/705,429, filed Jun. 26, 2020, each of which is hereby fully incorporated herein by reference.

### TECHNICAL FIELD

The present disclosure relates to an apparatus arranged to heat aerosolizable material.

### BACKGROUND

Articles such as cigarettes, cigars and the like burn tobacco during use to create tobacco smoke. Attempts have been made to provide alternatives to these articles, which burn tobacco, by creating products that release compounds without burning. Examples of such products are so-called heat-not-burn products, also known as tobacco heating products or tobacco heating devices, which release compounds by heating, but not burning, the material. The material may be for example tobacco or other non-tobacco products or a combination, such as a blended mix, which may or may not contain nicotine.

### SUMMARY

According to an aspect there is provided an apparatus arranged to heat aerosolizable material to volatilize at least one component of the aerosolizable material, the apparatus comprising: a conductive wire defining a receiving portion arranged to receive a consumable article comprising aerosolizable material; and a support structure encapsulating at least an outer edge of the conductive wire to thereby support the receiving portion. In an exemplary embodiment, the support structure encapsulates both the outer edge of the conductive wire and an inner edge of the conductive wire, thereby providing, in use, a separation layer between the conductive wire and the consumable article. In an exemplary embodiment, a thickness of the support structure between an inner surface of the support structure and the inner edge of the conductive wire is in the range 0.1 to 0.5 mm. In an exemplary embodiment, the support structure has a thickness of in the range of 1 mm to 5 mm. In an exemplary embodiment, the conductive wire has a substantially rectangular cross-section having a width in the range 2.75 mm ± 30% to 5.95 mm ± 30% and a thickness in the range 0.05 mm ± 30% to 0.1 mm ± 30%. In an exemplary embodiment, the conductive wire has a substantially circular cross-section having a diameter in the range 0.2 to 0.65 mm. In an exemplary embodiment, the support structure comprises a plastics material. In an exemplary embodiment, the support structure comprises polyether ether ketone (PEEK).

According to an aspect there is provided a method of manufacturing an apparatus arranged to heat aerosolizable material, the method comprising: forming a coil of conductive wire; encapsulating the coil of wire in a support structure, such that the encapsulated conductive wire forms a heating chamber arranged to receive a consumable article.

According to an aspect there is provided an arranged to heat aerosolizable material to volatilize at least one component of the aerosolizable material, the apparatus comprising: a metallic receiving portion arranged to receive a consumable article comprising aerosolizable material; a conductive wire disposed around the receiving portion, the conductive wire being arranged to generate heat for transfer to a received consumable aerosolizable material in response to application of an electric current; and a layer of oxide formed on a surface of the metallic receiving portion, the layer of oxide being disposed between the metallic receiving portion and the conductive wire. In an exemplary embodiment, the oxide layer is an anodized layer. In an exemplary embodiment, the receiving portion is a tube arranged to receive a cylindrical consumable article comprising aerosolizable material. In an exemplary embodiment, the tube has a diameter in the range 5 to 10 mm. In an exemplary embodiment, the conductive wire is arranged in a helix around the receiving portion. In an exemplary embodiment, the conductive wire comprises one or more of: aluminum, manganin, copper, steel, constantan, nickel, nichrome, stainless steel, silver, and fecralloy. In an exemplary embodiment, the conductive wire comprises one or more zones including a first zone and a second zone, the first zone extending from a distal end of the receiving portion to an intermediate point along the receiving portion, and the second zone extending from the intermediate point to a proximal end of the receiving portion. In an exemplary embodiment, the first zone extends by a length in the range 10 to 20 mm. In an exemplary embodiment, the second zone extends by a length in the range 25 to 30 mm. In an exemplary embodiment, the receiving portion comprises aluminum and the conductive wire is electrically isolated from the receiving portion by a layer of anodized aluminum. In an exemplary embodiment, the receiving portion comprises a tube of aluminum having a thickness in the range 0.05 to 0.15 mm. In an exemplary embodiment, a distal end of the receiving portion comprises a flared opening.

According to an aspect there is provided an apparatus arranged to heat aerosolizable material to volatize at least one component of the aerosolizable material, the apparatus comprising: a coil of conductive wire; and a support structure; wherein a resilience of the coil provides a clamping force to hold the coil in place on the support tube.

According to an aspect there is provided a method of manufacturing an apparatus arranged to heat aerosolizable material, the method comprising: providing a support structure arranged to receive a consumable article comprising aerosolizable material; and forming a coil of conductive wire around the support structure, wherein a resilience of the coil provides a clamping force to hold the coil in place on the support tube.

According to an aspect there is provided an apparatus arranged to heat aerosolizable material to volatize at least one component of the aerosolizable material, the apparatus comprising: a coil of conductive wire; a support structure, around which the coil of conductive wire is wound; and a clamping mechanism arranged to clamp the coil of conductive wire to the support structure. In an exemplary embodiment, the clamping mechanism comprises a first clamping portion and a second clamping portion, the first and second clamping portions being arranged to engage one another to surround the coil of conductive wire.

According to an aspect there is provided a method of manufacturing an apparatus arranged to heat aerosolizable material, the method comprising: providing a support structure arranged to receive a consumable article comprising aerosolizable material; forming a coil of conductive wire around the support structure; and providing a clamping mechanism to the conductive coil, the clamping mechanism being arranged to clamp the coil of conductive wire to the support structure.

### BRIEF DESCRIPTION OF THE DRAWINGS

Various embodiments will now be described, by way of example only, with reference to the accompanying drawings, in which:

FIG. 1 shows a schematic cross-sectional view of an example of an apparatus for heating an aerosolizable material to volatize at least one component of the aerosolizable material.

FIG. 2 shows a schematic cross-sectional view of an example of a conductive wire.

FIG. 3 shows a schematic cross-sectional view of an example of an apparatus for heating an aerosolizable material to volatize at least one component of the aerosolizable material.

FIG. 4 shows a schematic cross-sectional view of an example of an apparatus for heating an aerosolizable material to volatize at least one component of the aerosolizable material.

FIG. 5a shows a schematic cross-section view of an example of an apparatus for heating an aerosolizable material to volatize at least one component of the aerosolizable material.

FIG. 5b shows a schematic cross-section view of an example of an apparatus for heating an aerosolizable material to volatize at least one component of the aerosolizable material.

FIG. 6 is a perspective view of an example of an apparatus according to an embodiment.

### DETAILED DESCRIPTION

Apparatus is known that heats aerosolizable material to volatilize at least one component of the aerosolizable material, typically to form an aerosol which can be inhaled, without burning or combusting the aerosolizable material. Such apparatus is sometimes described as a “heat-not-burn” apparatus or a “tobacco heating product” or “tobacco heating device” or similar. Similarly, there are also so-called e-cigarette devices, which typically vaporize an aerosolizable material in the form of a liquid, which may or may not contain nicotine. In general, the aerosolizable material may be in the form of or provided as part of a rod, cartridge or cassette or the like which can be inserted into the apparatus. A heating material for heating and volatilizing the aerosolizable material may be provided as a “permanent” part of the apparatus or may be provided as part of the consumable article which is discarded and replaced after use. A “consumable article” in this context is a device or article or other component that includes or contains in use the aerosolizable material, which in use is heated to volatilize the aerosolizable material.

As used herein, the term “aerosolizable material” includes materials that provide volatilized components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenized tobacco or tobacco substitutes. The aerosolizable material can be in the form of ground tobacco, cut rag tobacco, extruded tobacco, reconstituted tobacco, reconstituted aerosolizable material, liquid, gel, gelled sheet, powder, or agglomerates, or the like. “Aerosolizable material” also may include other, non-tobacco products, which, depending on the product, may or may not contain nicotine. “Aerosolizable material” may comprise one or more humectants, such as glycerol or propylene glycol.

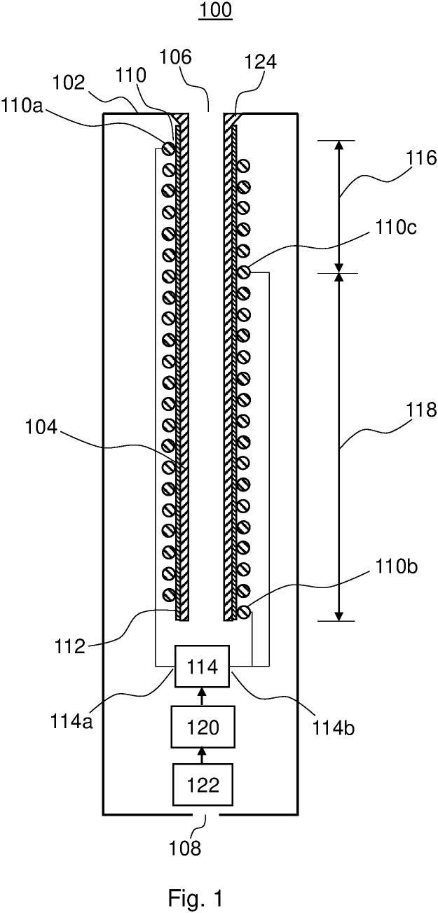

Referring to FIG. 1 there is shown a schematic cross-sectional view of an example of apparatus 100 according to an embodiment of the invention. The apparatus 100 is for heating aerosolizable material to volatilize at least one component of the aerosolizable material. The apparatus 100 comprises an apparatus housing 102, referred to hereinafter as a body 102. The body 102 comprises a receiving portion 104 for receiving at least a portion of a consumable article comprising aerosolizable material that is to be heated.

The apparatus 100 has an outlet 106 to permit volatilized components of the aerosolizable material to pass from the receiving portion 104 towards an exterior of the apparatus 100 when the consumable article is heated in use. The apparatus 100 has an air inlet 108 that fluidly connects the receiving portion 104 with the exterior of the apparatus 100. A user may be able to inhale the volatilized component(s) of the aerosolizable material by drawing the volatilized component(s) from the consumable article. As the volatilized component(s) are removed from the consumable article, air may be drawn into the receiving portion 104 via the air inlet 108 of the apparatus 100.

In this embodiment, the receiving portion 104 is cylindrical (i.e. circular in cross-section) and forms a recess or cavity for receiving at least a portion of the consumable article. The receiving portion 104 may have a diameter in the range 5 to 10 mm. In this embodiment, the receiving portion 104 comprises a flared opening 124. The receiving portion 104 may be made from a metallic material such as aluminum, copper, manganin, steel, constantan, nichrome, stainless steel, nickel and fecralloy (RTM). In this embodiment, the receiving portion 104 is of tubular construction arranged to receive a consumable article having a cylindrical form. However, in other embodiments, the receiving portion 104 may be arranged to receive consumable articles having other forms (i.e. non-cylindrical) and may accordingly have other geometries arranged to receive such consumable articles. For example, the receiving portion 104 may have a rectangular cross-section. In other embodiments, the receiving portion 104 may be other than a recess, such as a shelf, a surface, or a projection, and may require mechanical mating with the consumable article in order to co-operate with, or receive, the consumable article. In this embodiment, the receiving portion 104 is elongate, and is sized and shaped to accommodate a portion of the consumable article such that a further portion of the consumable article protrudes from the body 102. In other embodiments, the receiving portion 104 may be dimensioned to receive the whole of the consumable article. Typically, the receiving portion 104 has a wall thickness in the range 0.05 to 0.15 mm. For example, the receiving portion 104 may be a tube having a wall thickness of approximately 0.1 mm.

Around the receiving portion 104 is a conductive wire 110 arranged to generate heat in response to an applied electric current by resistive heating. The conductive wire 110 may take any suitable form. In this embodiment the conductive wire 110 is a coil of electrically conductive wire wrapped around the receiving portion 104 in a helical arrangement. The coil extends along a longitudinal axis that is substantially aligned with a longitudinal axis of the receiving portion 104.

Each turn of the coil is electrically isolated from adjacent turns. In this embodiment, each turn of the coil is separated from adjacent turns by an air gap. In some embodiments, the coil may be encapsulated in a dielectric material. Electrical isolation of the turns of the coil from adjacent turns prevents short circuits between the turns of the coil, which would otherwise affect the resistance of the coil and alter the heating characteristics of the conductive wire 110.

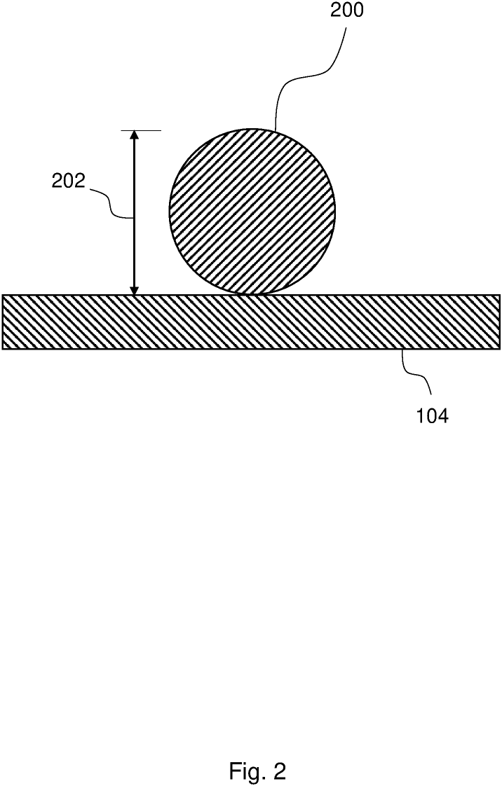

FIG. 2 shows a schematic cross-section of a wire 200 from which the conductive wire 110 may be formed to cooperate with the receiving portion 104. In this embodiment the wire 200 may be drawn or otherwise formed to have a substantially circular cross-section. In particular, the wire 200 has a diameter 202. In some embodiments, the diameter 202 of the wire is in the range of 0.2 to 0.65 mm. Wires having larger diameters may provide an increased area which is in contact with the receiving portion 104, and consequently may provide an improved thermal transfer of heat between the wire 200 and the receiving portion 104. An increased area of contact between the wire 200 and the receiving portion 104, and the consequential improvement of thermal contact between the wire 200 and the receiving portion 104, provides improved heat transfer between the wire 200 and the receiving portion 104 and therefore improves the heating efficiency of the apparatus 100. Alternatively, in other examples, wire of any other suitable cross sectional shape may be used, for example, rectangular cross sectional shape.

Once applied within the apparatus (i.e. wound around the receiving portion 104), the substantially circular form of the wire may deform so that its circular cross-section conforms with an outer surface of the receiving portion 104. For example, the circular cross-section of the wire may deform to become oval in cross section. Furthermore, the wire may conform to a radius of an outer surface of the receiving portion 104. In embodiments where the conductive wire 200 forms a helix, the conductive wire 200 may deform to form compound curves i.e. one conforming to a curve in an axis parallel to the longitudinal axis of the receiving portion 104 and one conforming to a curve in an axis perpendicular to the longitudinal axis of the receiving portion 104.

In this embodiment, the conductive wire 110 extends along substantially the whole length of the receiving portion 104. However, in other embodiments, the conductive wire 110 may extend along only a part of the receiving portion 104 (i.e. not along the full length of the receiving portion 104).

An outer surface of the receiving portion 104 comprises an insulating layer 112 to provide electrical isolation between the conductive wire 110 and the receiving portion 104. The insulating layer 112 may, for example, comprise a dielectric material. In some embodiments, the insulating layer 112 may be adhered to the outside surface of the receiving portion 104; for example, the insulating layer 112 may be a layer of polyimide film adhered to the outer surface of the receiving portion 104. In other embodiments, the insulating layer 112 may be an oxidation layer formed on the outer surface of the receiving portion 104; for example, the receiving portion 104 may be formed of a metal material and the insulating layer 112 may be formed of an oxide of that metal. In one example, the receiving portion 104 may be formed of aluminum and the insulating layer 112 may be an anodized layer formed of aluminum oxide. In some examples, the anodized layer may be formed by a process of so-called hard anodization. In some examples, the anodized layer has a thickness of between 15 nano meters and 25 micro meters.

In this embodiment, the conductive wire 110 is wrapped around the insulating layer 112 supported on the receiving portion 104. Resilience provided by the material from which the conductive wire 110 is made may provide a compressive force to hold the conductive wire 110 in contact with the insulating layer 112 on the surface of the receiving portion 104, thus improving thermal contact between the conductive wire 110 and the receiving portion 104. Alternatively, or additionally, a further component, e.g. an additional tube or one or more spring clips, may be arranged around the conductive wire 110 to hold or clamp it in place on the receiving portion 104. For example, in some embodiments, a clamping mechanism may comprise a first clamping portion and a second clamping portion, which are each arranged to engage one another to surround the coil of conductive wire. When the first and second clamping portions engage one another around the conductive wire 110, they may exert a compressive force on the conductive wire 110 to exert a force to urge the conductive wire 110 towards an outer surface of the receiving portion 104. In other embodiments, the conductive wire 110 may comprise an electrical trace formed between layers of dielectric material. For example, the electrical trace may be an etched trace formed between sheets of polyimide.

Although in the embodiment shown in FIG. 1, the conductive wire 110 is arranged in a coil, in other embodiments the conductive wire 110 may have other arrangements; for example, the conductive wire 110 may be arranged in a “zig-zag” pattern extending along a longitudinal axis of the receiving portion 104.

The conductive wire 110 may be formed of any suitable material. In some embodiments, the conductive wire 110 is formed of a metal material; for example, the conductive wire 110 may include one or more of: aluminum, copper, manganin, steel, constantan, nichrome, stainless steel, nickel and fecralloy (RTM), which is an alloy of iron, chrome and aluminum that has a relatively low resistance and can ramp up to a target temperature relatively quickly. In other embodiments, the conductive wire 110 may be formed of a ceramics material.

The apparatus 100 also comprises an electrical power source 114 for applying an electric current to the conductive wire 110 in use. In response to an applied electric current, resistive heating of the conductive wire 110 causes the temperature of the conductive wire 110 to increase. The electrical power source 114 of this embodiment is a rechargeable battery. In other embodiments, the electrical power source 114 may be other than a rechargeable battery, such as a non-rechargeable battery, a capacitor, a battery-capacitor hybrid, or a connection to an external power supply, such as a mains electricity supply or a USB powered electrical supply.

A first terminal 114a of the electrical power source 114 is electrically connected to a first end 110a of the conductive wire 110. A second terminal 114b of the electrical power source 114 is electrically connected to a second end 110b of the conductive wire 110. In this embodiment, an electrical connection is also made between the second terminal 114b of the electric power source 114 and an intermediate point 110c on the conductive wire 110 between the first end 110a and the second end 110b. Such an arrangement of electrical connections permits application of electrical power to different zones of the conductive wire 110. In particular, in this embodiment, a first zone 116 (referred to herein as Zone 1) is defined between the first end 110a and the intermediate point 110c between the first end 110a and the second end 110b, and a second zone 118 (referred to herein as Zone 2) is defined between the second end 110b and the intermediate point 110c between the first end 110a and the second end 110b. In other embodiments, the conductive wire 110 may be electrically connected to the electric power source 114 to define a single zone or may be electrically connected to the electric power source 114 to define more than two zones. The zones may be of substantially equal length or of different lengths to provide different heating characteristics in different heating zones. In some embodiments, Zone 1 116 extends along the conductive wire 110 (and therefore the receiving portion 104) for a length in the range 10 to 20 mm and Zone 2 118 extends along the conductive wire 110 (and therefore the receiving portion 104) for a length in the range 25 to 30 mm. In the embodiment shown in FIG. 1, Zone 1 116 extends along the conductive wire 110 (and therefore the receiving portion 104) for a length in the range 14 to 16 mm and Zone 2 118 extends along the conductive wire 110 (and therefore the receiving portion 104) for a length in the range 27 to 28 mm.

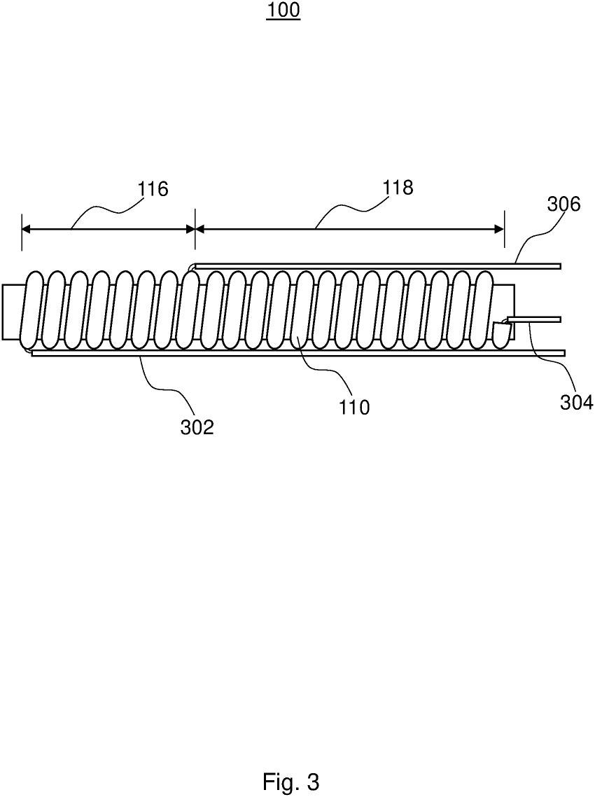

FIG. 3 is a schematic diagram showing a perspective view of the apparatus 100 with the conductive wire 110 wound around the receiving portion 104. In particular, FIG. 3 shows a first wire 302 (which is connected to the electric power source) connecting to the first end 110a of the conductive wire 110, a second wire 304 (which is connected to the electric power source) connecting to the second end 110b of the conductive wire 110 (to define Zone 1 116), and a third wire 306 (which is connected to the electric power source) connecting to the intermediate point 110c of the conductive wire 110 (to define zone 2 118).

The rate at which the temperature of the conductive wire 110 increases depends upon the power applied to the conductive wire 110 and the resistance of the conductive wire 110. In embodiments in which the electrical power source 114 is a rechargeable battery, the voltage provided by the battery is typically a minimum of approximately 2.7 Volts, but may be up to a voltage of 4.2 Volts, and can deliver and electrical current of up to a maximum of approximately 8.6 Amps. Accordingly, the maximum power that can be supplied by such a rechargeable battery is typically approximately 23 Watts. Therefore, a target resistance for the conductive wire 112 when powered by such a rechargeable battery is approximately 0.32 Ohms (0.35 Ohms ± 5%). Such a resistance enables the temperature of the conductive wire 110 to increase from room temperature (i.e. approximately 23° C.) to approximately 280° C. in approximately three seconds; i.e. at a rate of approximately 90° C. per second, which is comparable with heating rates of inductive wires arranged to heat consumable article comprising aerosolizable material.

The resistance of the conductive wire 110 is dependent on the resistivity of the material. Lower density materials have a lower mass and therefore require less energy and/or time to heat. Similarly, materials having a lower specific heat require less energy and/or time to heat. However, since density is inversely proportional to specific heat, both cannot be selected to be low and a balance must be found.

Regarding resistivity of the material, a balance must be found between the energy and/or time required to heat and the coverage of a surface that is to be heated. Higher resistivity materials require less material and therefore have a lower mass (and therefore require less energy and/or time to heat) but cover less of the surface to be heated, whereas lower resistivity materials require more material and therefore have a higher mass (and therefore require more energy and/or time to heat) but cover more of the surface to be heated.

With a target temperature rise of approximately 257° C., a maximum available power of approximately 23 Watts, the time taken to reach the desired temperature for a given volume of material, tᵥ (having units of s/mm³), can be calculated for different materials using the equation:

$${\text{t}}_{\text{v}} = \left(\text{Temperature Rise x Specific Heat x Density}\right) / \text{Power}$$

The controller 120 is electrically connected to the electrical power source 114. The controller 120 is for controlling the supply of electrical power from the electric power source 114 to the conductive heater 110. The controller 120 may, for example, comprise an integrated circuit (IC), such as an IC on a printed circuit board (PCB).

The controller 120 is operated by user-operation of a user interface 122. The user interface 122 is located at the exterior of the body 102. The user interface 122 may, for example, comprise a push-button, a toggle switch, a dial, a touchscreen, or the like. In other embodiments, the user interface 122 may be remote and connected to the rest of the apparatus wirelessly, such as via Bluetooth.

Operation of the user interface 122 by a user causes the controller 120 to enable the electrical power source 114 to pass an electrical current through the conductive heater 110, so as to cause the conductive heater 110 to generate heat by resistive heating.

In some examples, in use, the apparatus 100 is configured so that the conductive wire 110 heats the first zone 116 to a first zone target temperature and the second zone 118 to a second zone target temperature. The first zone 116 target temperature may be in the range of between about 240° C. and about 300° C., such as between about 250° C. and about 280° C. Likewise, the second zone 118 target temperature may also be in the range of between about 240° C. and about 300° C., such as between about 250° C. and about 280° C. In some examples, the apparatus 100 is configured so that the conductive wire 110 first heats the first zone 116 to the first zone target temperature and then later heats the second zone 118 to the second zone target temperature (or vice versa).

In some examples, in use, the apparatus 100 is configured so that the conductive wire 110 heats the first zone 116 to the first zone target temperature in a ramp up time of between 2 to 40 seconds, such as between 2 to 10 seconds, for example 2 to 5 seconds. Likewise, in use, the apparatus 100 is configured so that the conductive wire 110 heats the second zone 118 to the second zone target temperature in a ramp up time of between 2 to 40 seconds, such as between 2 to 10 seconds, for example 2 to 5 seconds.

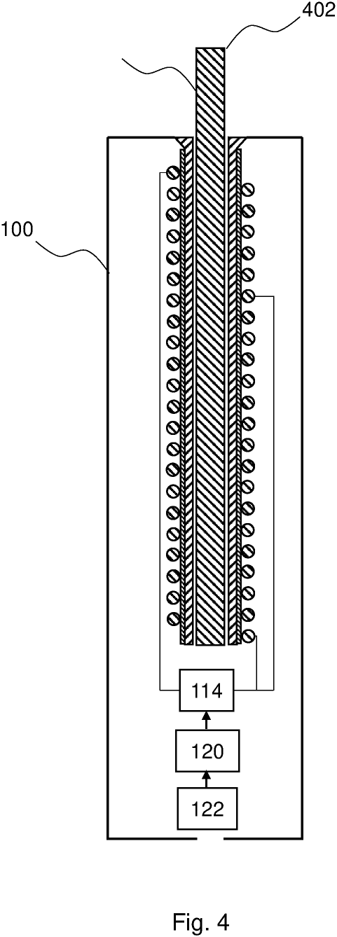

FIG. 4 shows an apparatus 100, as described above with reference to FIG. 1, in use with a consumable article 400 inserted into the receiving portion 104. As described above, the consumable article 400 may be inserted into the apparatus 100 to be heated to release (i.e. volatize) components present in aerosolizable material present in the consumable article 400. An end 402 of the consumable article 400 may, in some embodiments act as a mouthpiece from which volatized components from the aerosolizable material may be drawn.

When a consumable article is present in the receiving portion 104, and the controller 120 controls the electric power source 114 to pass an electric current through the conductive wire 110, heat from the conductive wire 110 heats the aerosolizable material to volatize components of the aerosolizable material.

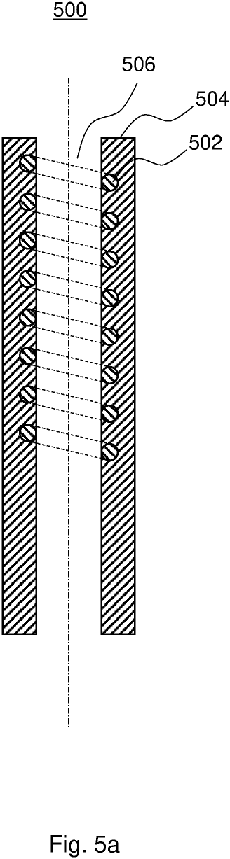

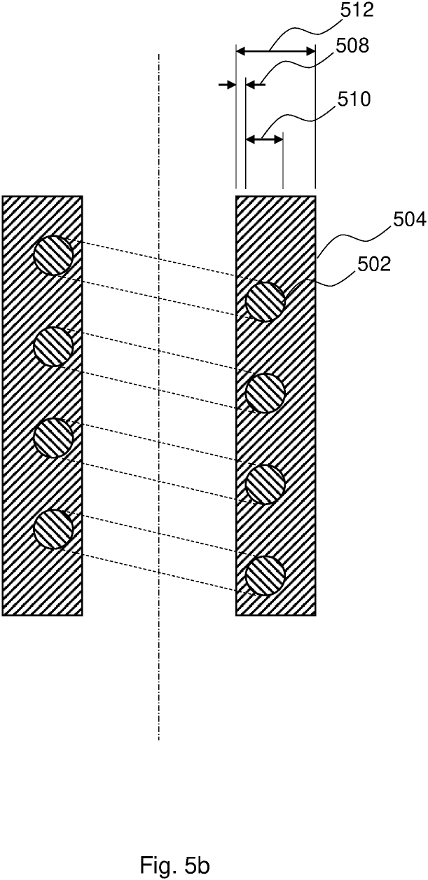

FIG. 5a shows an apparatus 500 according to an embodiment in which the receiving portion is defined by the conductive wire itself. That is, there may be no separate receiving portion, such as a tube, between the conductive wire and the space in which a consumable article is to be received. In the embodiment shown in FIG. 5, outward facing surfaces of a conductive wire 502 (e.g. a coil) may be supported and/or mounted on an internal surface of a support structure 504, such that the conductive wire 502 and the support structure 504 form a heating chamber defining a space 506 for receiving a consumable article, without the need for a separate, thermally conductive, internal support structure around which the conductive wire 502 is wound. Such an embodiment may improve the transfer of heat energy from the conductive wire 502 to aerosolizable material in a received consumable article.

As shown in FIG. 5b, which shows an enlarged view of a portion of the embodiment shown in FIG. 5a, in some embodiments, the conductive wire 502 may be completely encapsulated by the support structure 504. The support structure 504 may define a separation layer 508 between the conductive wire 502 and the space 506 in which a consumable article is to be received. The separation layer 508 may have a thickness up to 0.5 mm. In one specific embodiment, the separation layer 508 has a thickness of approximately 0.26 mm. However, in some embodiments, the conductive wire 502 may not be completely encapsulated by the support structure 504 such that an inner face of the conductive wire 502 is exposed to the space 506 in which a consumable article is to be received, so that the conductive wire 502 is directly contactable with a received consumable article. That is the separation layer 508 may have a thickness in the range 0.1 mm to 0.5 mm.

In some embodiments, the conductive wire 502 may have a substantially rectangular cross-section. In particular, the wire 502 may have a width and a thickness. In some embodiments, the width 202 of the wire is in the range of 2.75 mm ± 30% to 5.95 mm ± 30%. In some embodiments, the thickness of the wire is in the range of 0.05 mm ± 30% to 0.1 mm ± 30%.

In some embodiments, the support structure 504 may be made of a plastics material capable of withstanding temperatures necessary to volatize one or more components of the aerosolizable material. For example, the support structure may comprise polyether ether ketone (PEEK).

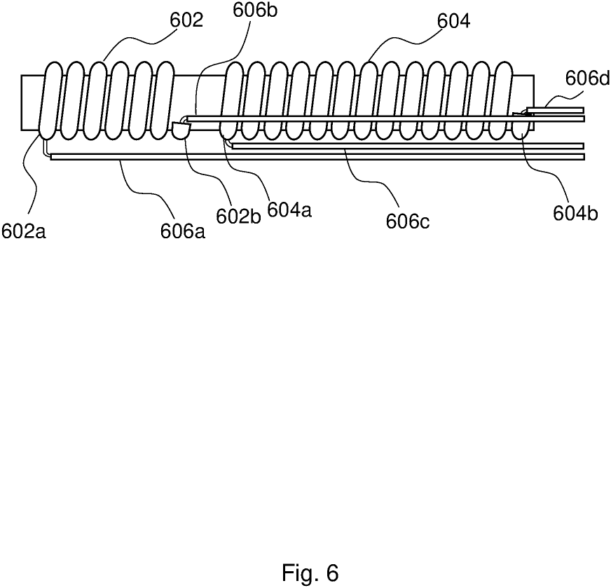

FIG. 6 is a perspective view of another example of apparatus 600 according to an embodiment of the invention. The apparatus shown in FIG. 6 is similar to the apparatus shown in FIG. 3 but includes multiple coils to define different heating zones; in this example, a first coil 602 and a second coil 604.

The first coil 602 has a first end 602a and a second end 602b that are electrically connected (e.g. by a crimp joint or solder joint) to a first power wire 606a and a second power wire 606b respectively. Similarly, the second coil 604 has a first end 604a and a second end 604b that are electrically connected (e.g. by a crimp joint or solder joint) to a first power wire 606c and a second power wire 606d respectively. Each of the first and second coils 602, 604 are wrapped in a helical arrangement around the receiving portion 104. Each of the power wires 606a - 606d may comprise a conductive core covered with an electrically insulating sheath. In some examples the insulating sheath may be formed from polyether ether ketone (PEEK).

In use the first coil 602 is arranged to heat a first heating zone of the receiving portion 104 and the second coil 604 is arranged to heat a second zone of the receiving portion 104. The first heating zone may extend from a distal end of the receiving portion 104 to a boundary point along the receiving portion 104, and the second heating zone may extend from the boundary point to a proximal end of the of the receiving portion 104. In some examples, the first heating zone extends by a length in the range 10 to 15 mm. In some examples, the second heating zone extends by a length in the range 20 to 30 mm.

The ends of the first and second coils comprise tabs that provide space on which to form an electrical connection (for example, via a crimp joint or solder joint) with a power source via power wires 606a - 606d.

The various embodiments described herein are presented only to assist in understanding and teaching the claimed features. These embodiments are provided as a representative sample of embodiments only and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An apparatus arranged to heat aerosolizable material to volatilize at least one component of the aerosolizable material, the apparatus comprising:
a conductive wire defining a receiving portion arranged to receive a consumable article comprising aerosolizable material; and
a support structure encapsulating at least an outer edge of the conductive wire to thereby support the receiving portion.

2. The apparatus as claimed in claim 1, wherein the support structure encapsulates both the outer edge of the conductive wire and an inner edge of the conductive wire, thereby providing, in use, a separation layer between the conductive wire and the consumable article.

3. The apparatus as claimed in claim 2, wherein a thickness of the support structure between an inner surface of the support structure and the inner edge of the conductive wire is in the range of 0.1 to 0.5 mm.

4. The apparatus as claimed in claim 1, wherein the support structure has a thickness in the range of 1 mm to 5 mm.

5. The apparatus as claimed in claim 1, wherein the conductive wire has a substantially rectangular cross-section having a width in the range of 2.75 mm ± 30% to 5.95 mm ± 30% and a thickness in the range 0.05 mm ± 30% to 0.1 mm ± 30%.

6. The apparatus as claimed in claim 1, wherein the conductive wire has a substantially circular cross-section having a diameter in the range of 0.2 to 0.65 mm.

7. The apparatus as claimed in claim 1, wherein the support structure comprises a plastics material.

8. The apparatus as claimed in claim 1, wherein the support structure comprises polyether ether ketone (PEEK).

9. A method of manufacturing an apparatus arranged to heat aerosolizable material, the method comprising:
forming a coil of conductive wire; and
encapsulating the coil of conductive wire in a support structure, such that the encapsulated conductive wire forms a heating chamber arranged to receive a consumable article.

10. An apparatus arranged to heat aerosolizable material to volatilize at least one component of the aerosolizable material, the apparatus comprising:
a metallic receiving portion arranged to receive a consumable article comprising aerosolizable material;
a conductive wire disposed around the receiving portion, the conductive wire being arranged to generate heat for transfer to a received consumable aerosolizable material in response to application of an electric current; and
a layer of oxide formed on a surface of the metallic receiving portion, the layer of oxide being disposed between the metallic receiving portion and the conductive wire.

11. The apparatus as claimed in claim 10, wherein the layer of oxide is an anodized layer.

12. The apparatus as claimed in claim 11, wherein the layer of oxide is a hard-anodized layer having a thickness of between 15 nano meters and 25 micro meters.

13. The apparatus as claimed in claim 10, wherein the receiving portion is a tube arranged to receive a cylindrical consumable article comprising aerosolizable material.

14. The apparatus as claimed in claim 13, wherein the tube has a diameter in the range of 5 to 10 mm.

15. The apparatus as claimed in claim 10, wherein the conductive wire is arranged in a helix around the receiving portion.

16. The apparatus as claimed in claim 10, wherein the conductive wire comprises one or more of: aluminum manganin, copper, steel, constantan, nickel, nichrome, stainless steel, silver, and fecralloy.

17. The apparatus as claimed in claim 10, wherein the conductive wire comprises one or more zones including a first zone and a second zone, the first zone extending from a distal end of the receiving portion to an intermediate point along the receiving portion, and the second zone extending from the intermediate point to a proximal end of the receiving portion.

18. The apparatus as claimed in claim 17, wherein the first zone extends by a length in the range of 10 to 20 mm.

19. The apparatus as claimed in claim 17, wherein the second zone extends by a length in the range of 25 to 30 mm.

20. The apparatus as claimed in claim 17, wherein the conductive wire comprises a first coil separate from a second coil, the first coil comprising the first zone and the second coil comprising the second zone.

21. The apparatus as claimed in claim 17, wherein the conductive wire comprises a single coil and the single coil comprises the first zone and the second zone.

22. The apparatus as claimed in claim 17 wherein at least one of: the first zone has a target temperature within the range of 240° C. and 300° C. or the second zone has a target temperature within the range of 240° C. and 300° C.

23. The apparatus as claimed in claim 17 wherein at least one of: the first zone has a ramp up time within the range of 2 to 40 seconds or the second zone has a ramp up time within the range of 2 to 40 seconds.

24. The apparatus as claimed in claim 10, wherein the receiving portion comprises aluminum and the conductive wire is electrically isolated from the receiving portion by a layer of anodized aluminum.

25. The apparatus as claimed in claim 24, wherein the receiving portion comprises a tube of aluminum having a thickness in the range of 0.05 to 0.15 mm.

26. The apparatus as claimed in claim 10, wherein a distal end of the receiving portion comprises a flared opening.

27. An apparatus arranged to heat aerosolizable material to volatize at least one component of the aerosolizable material, the apparatus comprising:
a coil of conductive wire; and
a support structure;
wherein a resilience of the coil provides a clamping force to hold the coil in place on the support structure.

28. A method of manufacturing an apparatus arranged to heat aerosolizable material, the method comprising:
providing a support structure arranged to receive a consumable article comprising aerosolizable material; and
forming a coil of conductive wire around the support structure, wherein a resilience of the coil provides a clamping force to hold the coil in place on the support structure.

29. An apparatus arranged to heat aerosolizable material to volatize at least one component of the aerosolizable aerosolisable material, the apparatus comprising:
a coil of conductive wire;
a support structure around which the coil of conductive wire is wound; and
a clamping mechanism arranged to clamp the coil of conductive wire to the support structure.

30. The apparatus as claimed in claim 29, wherein the clamping mechanism comprising a first clamping portion and a second clamping portion, the first clamping portion and the second clamping portion being arranged to engage one another to surround the coil of conductive wire.

31. A method of manufacturing an apparatus arranged to heat aerosolizable material, the method comprising:
providing a support structure arranged to receive a consumable article comprising aerosolizable material;
forming a coil of conductive wire around the support structure; and
providing a clamping mechanism to the conductive coil, the clamping mechanism being arranged to clamp the coil of conductive wire to the support structure.
